(19) United States
(12) Patent Application Publication
(10) Pub. No.: US 2012/0251097 A1
(43) Pub. Date: Oct. 4, 2012

(54) PASSIVE ARCHITECTURAL OPTICAL DISTRIBUTION NETWORK

(75) Inventors: Ahmad Elmardini, Dallas, TX (US); Russell W. Brown, Coppell, TX (US)

(73) Assignee: Tellabs Operations, Inc., Naperville, IL (US)

(21) Appl. No.: 13/177,081

(22) Filed: Jul. 6, 2011

Related U.S. Application Data
(60) Provisional application No. 61/468,229, filed on Mar. 28, 2011.

(51) Int. Cl. H04B 10/08

(52) U.S. Cl. 398/5; 398/17

(57) ABSTRACT

Passive optical networks can experience faults that are unrecoverable. An embodiments of the present invention is a hybrid passive optical network configured to protect a primary optical path employing a switch to transmit data from the primary path to a secondary path in a passive manner. In an event data flows through both the primary path and the secondary path, the optical switch may be configured to monitor the primary path. In such an embodiment, the optical switch is a protection optical switch that is sensitive to monitoring an optical signal that flows on the primary path. If the switch detects a loss of signal on the primary path, the optical switch automatically switches delivery of the optical signal from the primary path to the secondary path, via the optical switch to allow an optical line terminal to receive optical signals virtually uninterrupted.

### RELATED APPLICATION

This application claims the benefit of U.S. Provisional Application No. 61/468,229, filed on Mar. 28, 2011. The entire teachings of the above Application are incorporated herein by reference.

### BACKGROUND OF THE INVENTION

Passive optical networks are may be employed in telecommunications to provide network services to end users. Currently, passive optical networks typically include a service provider network, content server network, optical line terminal, optical splitter/combiner, optical network units, and optical network terminals connected via optical fiber. Implementation of currently used passive optical networks has been expensive and is widely used for service providers to provide point-to-multipoint service to multiple customers.

### SUMMARY OF THE INVENTION

An example embodiment of the present invention includes a central office or central portion of an optical network that includes a primary and a secondary optical line terminal (OLT). The example embodiment includes the primary OLT connected to a passive optical network (PON) via a primary path and configured to transmit first data to an optical network terminal (ONT) via the PON. The secondary OLT may be configured to communicate to the PON via an optical switch in an event the optical switch detects a loss of signal event on the first PON.

Further example embodiments of the present invention include a central office that includes a primary OLT, secondary OLT, and switch. The primary OLT is connected to a first PON via a primary path and configured to transmit first data to a first ONT via the first PON and the secondary OLT connected to a second PON via a secondary path and configured to transmit second data to a second ONT via the second PON. The example embodiment further includes the switch being operably interconnected to the primary and secondary paths, the switch configured to monitor the primary path for a loss of signal event and, in such an event, switch the first data to the second path, the second path configured to communicate the first data to the first ONT via the first PON and the second data to the second ONT via the second PON.

Further example embodiments of the present invention may include a hybrid passive optical network that includes a first PON path spanning between a primary OLT and an ONT and a second PON path spanning between a secondary OLT and the ONT via a physical optical switch. In the example embodiment, the physical optical switch is operably interconnected to the first and second PON paths, the switch being configured to detect a loss of signal event on the first PON path, and, responsive to the event, optically couple the secondary OLT to the ONT.

### BRIEF DESCRIPTION OF THE DRAWINGS

The foregoing will be apparent from the following more particular description of example embodiments of the invention and as illustrated in the accompanying figures. The drawings are not necessarily to scale, emphasis instead being placed upon illustrating example embodiments of the present invention.

The accompanying figures where like reference numerals refer to identical or functionally similar elements throughout the separate views and which together with the detailed description below are incorporated in and form part of the Specification, serve to illustrate various embodiments further and to explain various principles and advantages all in accordance with example embodiments of the present invention disclosed herein.

FIG. 1 is a network diagram of an example embodiment of the invention that illustrates an optical network.

FIG. 2 is a network diagram of an example embodiment of the invention that illustrates a portion of an optical network.

FIG. 3 is a network diagram of an example embodiment of the invention that illustrates passive optical networks interconnected to active portions of a network.

FIG. 4 is a block diagram 400 according to an example embodiment of the present invention.

FIG. 5 is a flow chart of an example embodiment of the present invention that illustrates transmitting data to a optical network terminal.

### DETAILED DESCRIPTION OF THE INVENTION

A description of example embodiments of the invention follows.

Before describing embodiments of the present invention, a brief description of history and current developments of the art is presented.

An optical network provides for the transfer or communication of signals over optical fibers. The optical network may include multiple components and can be thought of as including a core network and an access network. The core network provides for network paths for data transmission between interconnected network elements, such as routers, gateways, or sub-networks. Such network paths may connect an upstream service provider to a downstream end-user or customer, and vice versa.

Telecommunications channels may be any paths through which data is transmitted, where such data may include voice, video, analogue, or digital data and may be transmitted on many mediums. Such telecommunications channels may be any medium for transmitting signals, such as copper wires, coaxial cables, fiber-optic cables, or other such medium currently employed or hereinafter developed in the art.

A passive optical network is a type of fiber-optic access network that provides for point-to-multipoint service, for example, from a single network element to multiple end-users. In some networks, a central office may be located between the core network and the access network, or other locations as deemed useful, where the central office may include common electricity to provide electrical power for circuitry and may provide control functionality for the passive optical network interfaced with the central office. The central office may contain multiple optical line terminals (OLTs), which may be concatenated or slotted in a chassis to provide service or interfaces between the network, OLTs, and associated optical network units (ONUs).

ONUs are network interface devices that may be used as an end-terminal where an optical signal is transmitted from the network to a customer premises. The ONU essentially terminates the fiber-optic line and de-multiplexes (or splits) the optical signal for use by the customer. The ONU may be coupled or interconnected with optical network terminals (ONTs), which are end-user devices. The ONT must derive its power, for example, from the customer premises equipment, or, the ONT must maintain its own power source.

In a standard passive optical network, passive splitters are employed to divide the different wavelengths of light among all ONTs as provided for according to the control units or method of providing data, such as a wave division multiplexing. Currently, upstream data transmission (e.g., from ONT to OLT) is transmitted at 1310 nanometers (nm) spaced wavelengths and downstream data transmission (e.g., from OLT to ONT) is transmitted at 1490 nm spaced wavelengths. The splitters are purely passive and require no power; therefore, the splitters may be placed at any location in the field without the need for a separate power source.

Previous techniques have been proposed or implemented for providing switching of optical signals in a network where a switch is located in the field, for example, 10 to 20 kilometers away from a central office. In one such example of a previous technique, the network has a proximal end and a distal end, the proximal end is closer to the OLT (located near or in the central office) than the PON (such as an ONT), the distal end is closer to the PON than the OLT, and the switch of a previous technique is located at the distal end of the network, closest to the PON. Such techniques locate the switch close to the passive optical network, such as at a 1:32 splitter site, where the 1:32 splitter site is located at the distal end of the network. Such techniques may allow for switching between a primary path and a secondary path in cases of failure or loss of signal; however, in order to maintain the switch in the field, the switch must be an active component located in the optical distribution network, which requires its own power source. Such techniques are expensive and may complicate network deployment and planning in order to configure the network to maintain power at the switching device.

Example embodiment of the present invention provide for a passive architectural optical distribution network for remote monitoring bypass and protection switch with no redundancy. Example embodiments provide for protection of a primary path by employing a switch, interconnected to a secondary path, located near or in the central office, thereby providing a switch without the need of its own power supply.

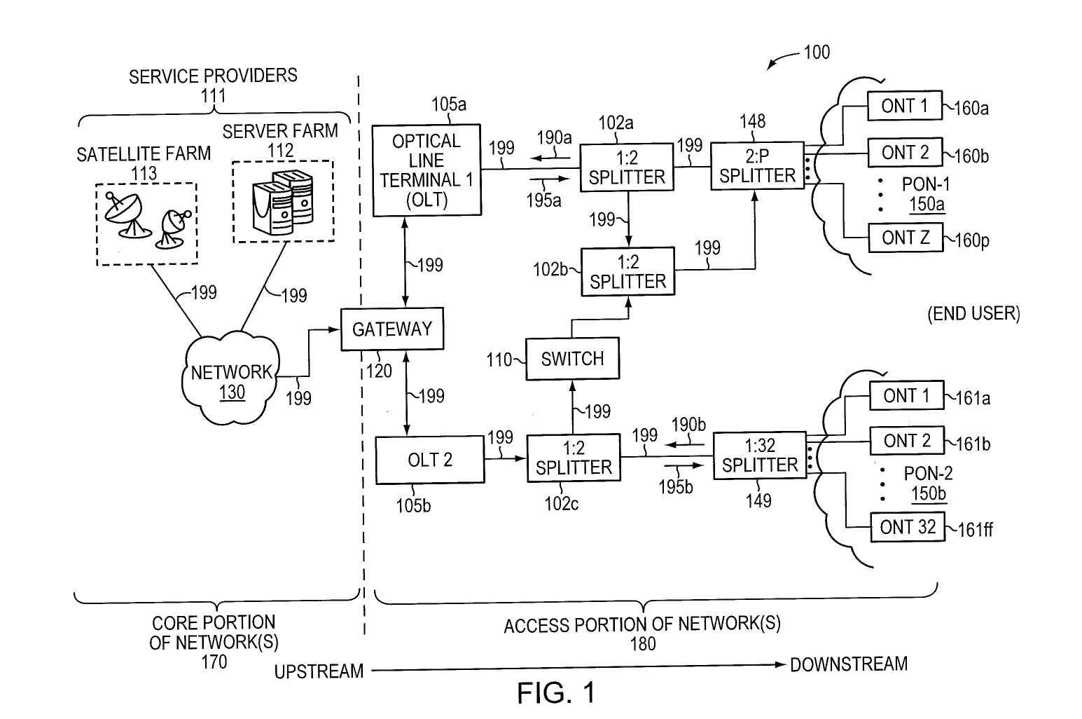

FIG. 1 is a network diagram of an example embodiment of the invention that illustrates an optical network 100. The optical network 100 may be any optical network or combination of optical networks, such as a Synchronous Optical Network (SONET) or mesh-based optical network, and may include a plurality of network elements such as equipment of service providers 11, a network 130, optical line terminals 105a-b, and a switch 110. The optical network 100 may be logically or physically interconnected via paths 199, where such paths may be any optical connection, such as a fiber optic cable.

An example embodiment of the optical network 100 may include a core portion 170 of the optical network (core network) and an access portion 180 of the optical network (access network). In one such example embodiment, the core network 180 may include upstream network elements such as the service providers 111 including satellite farms 113 and content servers 112, which may provide data downstream to intervening optical networks, such as network 130, network elements, and, ultimately an end-user. Example embodiments of the optical network 100 may include additional network elements or intervening networks, such as network 130 and gateway 120, where such network 130 may interface with a network node such as the gateway 120, which may allow for system interoperability between the core network 170 and the access network 180.

Alternative example embodiments of the optical network 100 may include other network nodes for interfacing between network elements, such as a network router, or similar such device, which may be logically or physically interconnected. Further alternative example embodiments may include the optical network 100 interfacing with a non-optical network, such as termination points interconnected via wires, cables, or intermediary equipment that may be located at the end-user, downstream side of the network 100 or in alternative locations in the access network 180.

Further example embodiments of the present invention may include the network 100 including a passive optical network (PON), where the service providers 111 may send and receive optical signals to and from optical line terminals (OLTs), such as OLT1 105a and OLT2 105b via an optical line connector, such as optical fiber 199. The OLT1 105a may be configured to send a downstream signal 195a and receive an upstream signal 190a via the optical fibers 199, where the downstream signal 195a and upstream signal 190a may pass through additional network elements, such as optical splitters/combiners 102a-b (also referred to herein as “optical splitters” or “OSCs”). Further example embodiments of the present invention may include OLT2 105b configured to send a downstream signal 195b and receive an upstream signal 190b via the optical fibers 199. The downstream signals 195a-b and the upstream signals 190a-b may be the same or different signals. In example embodiments of the present invention, the OLT1 105a may be operably interconnected to at least one OSC, such as OSC 102a, which, in turn may, be operably interconnected to additional OSCs, such as OSC 102b, and a switch 110. Similarly, the OLT2 105b may be operably interconnected to at least one OSC, such as OSC 102c, which may be further interconnected to the switch 110.

The switch 110 may be an optical cross-connect switch to switch high-speed optical signals in an optical network or electrical switch. Example embodiments of the switch 110 may operate at the Physical Layer (Layer 1 in the Open System Interconnection (OSI) communications model). Example embodiments of the switch 110 may include units or modules for providing switching and routing of optical signals; network monitoring of other network elements, network paths, and network connections; network protection and restoration; and additional functions currently employed or hereinafter developed directed towards optical network switching. In alternative example embodiments of the optical network 100, the switch 110 may be a passive switch, which does not require a power system to function.

Such OSCs 102a-b are illustrated as 1:2 OSCs, and may connect to additional OSCs, such as OSC 148, which is illustrated as a 2:P OSC. The 2:P OSC 148 may be implemented as an OSC in communication with P number of ONTs via P number of output ports from 2 input ports; for example, the OSC 148 could be a 2:16 OSC with two input lines entering 2 input ports of the OSC 148 and configured to be in communication with 16 ONTs, ONT1 160a to ONT16 160p via a first passive optical network (PON), such as PON-1 150a. Typically, in today's practice, an OSC may be in communication with thirty-two ONTs, such as OSC 149, which is a 1:32 optical splitter; although in the future, communication connections may be increased using currently known or hereinafter developed methods of electrical, optical, or other communication techniques in the art. Further example embodiments of the present invention include the PON-2 150b, which includes or is interconnected to ONTs 160a-p and 161a-ff being operably interconnected with end users (not shown) via communication paths (not shown), where such communication paths may be, for example, optical, electrical, radio frequency, or other currently known or hereinafter developed communication paths.

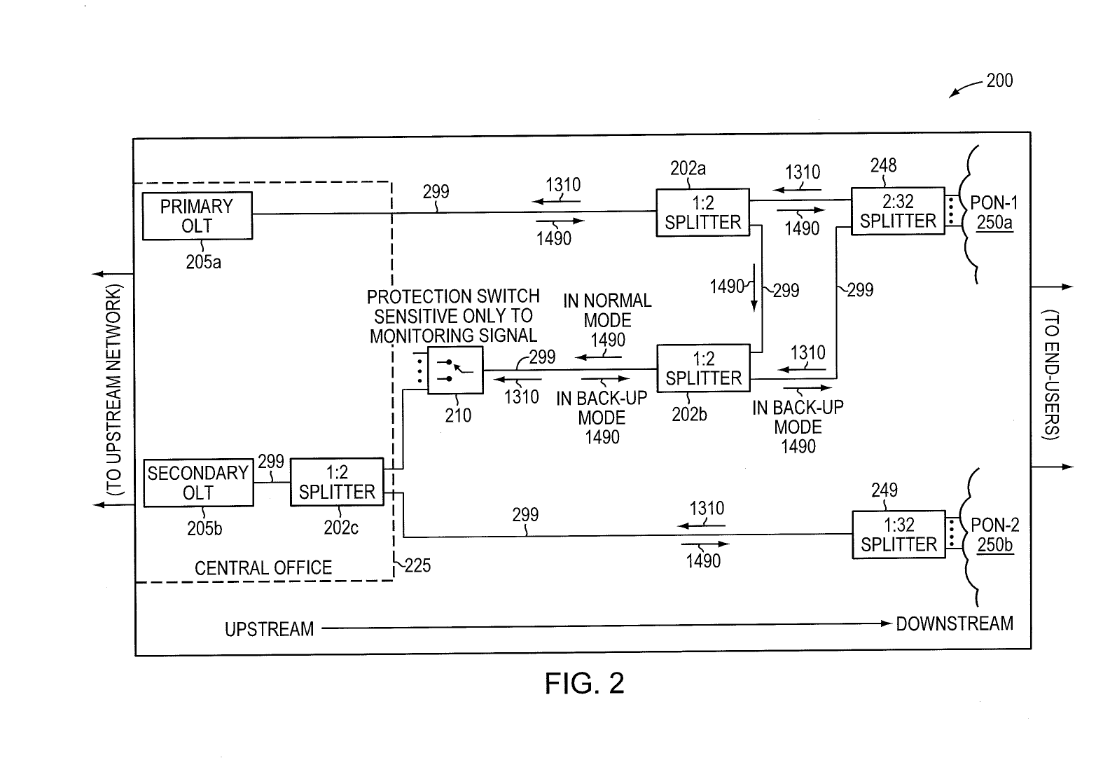

FIG. 2 is a network diagram of a portion of a network 200, such as the optical network 100 of FIG. 1, which illustrates example embodiments of the present invention. The network portion 200 may include a primary optical line terminal (OLT) 205a and a secondary OLT 205b in communication with a first passive optical network (PON) 250a and a second PON 250b. The primary OLT 205a and secondary OLT 205b may be located in a central location of a telecommunication network, such as optical network 100 of FIG. 1, where the central location may be a core network location such as central office 225. The central office 225 may be equipped with a system of electronic, optical, mechanical, or other such equipment, including, for example the primary and secondary OLTs 205a-b and protection switch (also referred to herein as “switch”) 210. Example embodiments of the central office 225 may further include common electricity to provide electrical power for circuitry and may provide control functionality for the passive optical network interfaced with the central office as is known in the art.

In alternative example embodiments of the present invention, additional OSCs and additional switches may be maintained such that more than two optical line terminals may be servicing additional PONs (not shown), in such a manner that allows for the example embodiment of FIG. 2 to be cascaded. Such an alternative example embodiment may allow for a stackable system that may include, for example, a tertiary OLT (not shown), connected to the secondary OLT 205b in the same or substantially similar manner as the secondary OLT 205b is connected to the primary OLT 205a, where the tertiary OLT would provide a back-up or protection path for either the primary OLT 205a and/or the secondary OLT 205b.

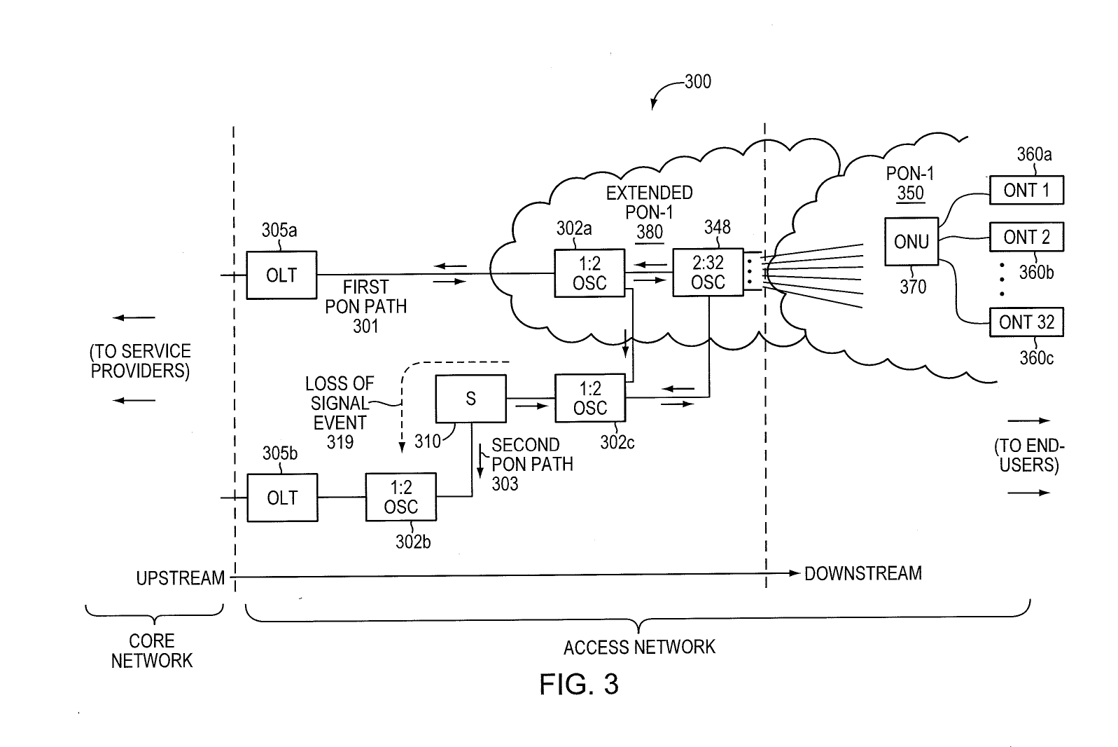

FIG. 3 is a network diagram of a hybrid passive optical network 300, such as the optical network 100 of FIG. 1, which illustrates example embodiments of the present invention. The example embodiment of FIG. 3 illustrates an example of the hybrid passive optical network 300 that includes a first passive optical network (PON) path 301 spanning between a primary optical line terminal (OLT) 305a and an optical network unit (ONU) 370, which is interconnected to optical network terminals (ONTs) 360a-c. The example embodiment of FIG. 3 further includes a second PON path 303 spanning between a secondary OLT 305b and the ONTs 360a-c via a physical optical switch 310. In the example embodiment, the physical optical switch 310 is operably interconnected to the first and second PON paths 301 and 303, respectively. The example embodiment of the switch 310 may be configured to detect a loss of signal event 319 on the first PON path 301; responsive to the event, the switch 310 may couple the secondary OLT 305b to the ONTs 360a-b. The example embodiment of the present invention may further be configured to include an extended PON, such as extended PON-1 380, which may include additional passive optical components, such as additional OSCs, or other such network components included in a PON. The example embodiment of FIG. 3 may be a hybrid PON by including a single active component, namely the switch 310, located at or near the central office, such that the switch 310 receives its power from the central office and all other network elements or components are purely passive.

In alternative example embodiments of the present invention, the OLTs may be connected to the ONTs through a PON-1 350, where the PON-1 350 includes only passive network elements. Further example embodiments of the present invention may include additional network elements configured between the OLTs and the ONTs, such as optical splitters/combiners (OSC) 302a-c. Alternative example embodiments of the present invention may further include the OLTs receiving signals from the same or different upstream network or network element, such as a gateway interconnected to a core network of the optical network. In such example embodiments of the present invention that include the OLTs receiving signals from different upstream network elements, the signals received may be the same, substantially the same, or different signals.

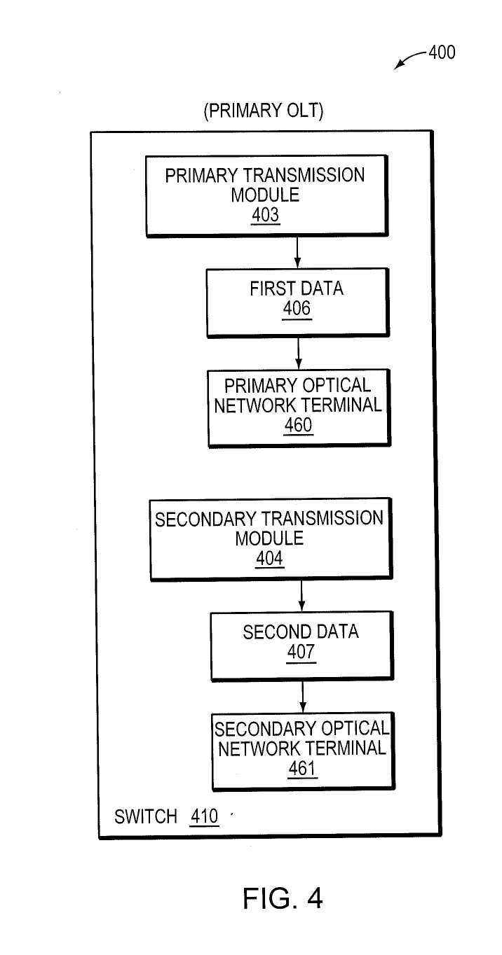

FIG. 4 is a block diagram 400 of a switch 410, as in the switch 110 in FIG. 1, according to an example embodiment of the present invention. Components of the switch 410 can include a primary transmission module 403 and a secondary transmission module 404. The primary transmission module 403 can transmit first data 406 to a primary optical network terminal 460. The secondary transmission module 404 can transmit second data 407 to a secondary optical network terminal 461. Alternative example embodiments of the present invention can include different modules being configured to transmit data or interconnect the transmission modules 403 and 404.

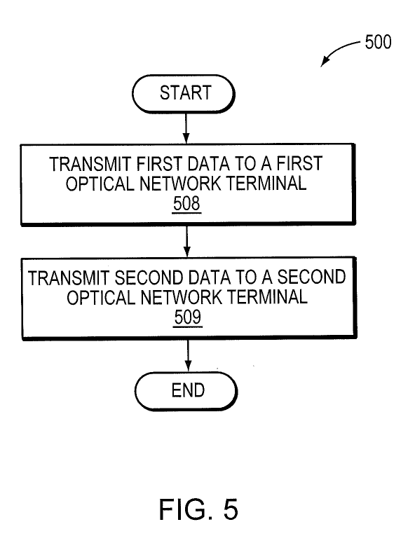

FIG. 5 is a flow chart 500 of an embodiment of the present invention illustrating transmitting data to a optical network terminal. According to the example embodiment, the flow chart 500 transmits first data to a first optical network terminal (ONT) (508) and transmits second data to a second optical network terminal (509). Alternative example embodiments of the present invention can provide for data to flow upstream from an end-user or ONT toward an optical line terminal (OLT) and downstream from an OLT, or other interconnected network or network element, toward an end-user or ONT.

Example embodiments of the present invention may include, for example, network architecture such as an optical local area network (LAN), where the optical LAN has a proximal end and a distal end, where the proximal end is closer to the OLT than the PON and the distal end is closer to the PON than the OLT. In one such example embodiment, the switch is located at the proximal end of the optical LAN, for example, the switch may be located at a secondary OLT. A splitter may be located at, near, or within a central office (that contains a power supply) and may include optical circuitry that may pass a portion of a signal traveling on a primary path and transmit the portion of the signal through the secondary path via the switch. The switch may be configured to contain circuitry that may monitor the primary path. At the switch, upon detection of a failure, for example a loss of signal event, the switch switches the signal from the primary path to the secondary path of the secondary OLT, which may be configured to act as a back-up or protection OLT.

In alternative example embodiments of the present invention, a back-up or protection OLT may be configured to handle a sixty-four optical network terminal (ONT) passive optical network (PON). In such an example embodiment, an optical splitter, such as a 1:2 optical splitter, for the back-up OLT may be configured to handle two 1:32 PONs at the same or substantially the same time in loss of signal events or other such emergency events. In such example embodiments, during a normal event such as a non-loss of signal event, a primary OLT may be interconnected to a first 1:32 PON and the secondary OLT may be interconnected to a second 1:32 PON. In such an example embodiment, during an emergency or loss of signal event, the switch may be configured to connect the primary OLT PON to the secondary OLT, which may be connected to a 1:64 PON until the primary OLT recovers or returns to normal operation. In such example embodiments, the secondary OLT is not a redundant OLT.

Alternative example embodiments of the present invention may further allow for a system, apparatus, or architecture for providing protection (back-up) capabilities of a fiber optic path in a passive manner. Such example embodiments may include a switch that includes at least one input port and at least one output port for receiving and transmitting data. Further example embodiments of the present invention may include a switch that includes two input ports or interfaces and one output port or interface. In an event where data flows through both the primary and the secondary path (also referred to as “normal operation”), the secondary path may be configured to monitor the primary path. However, in an event where data fails to flow through the primary path, for example, if there is a loss of signal detected, the data from the primary and the secondary path flows through the secondary path to its original or determined destination or next hop.

It should be understood that the optical switch in the foregoing example embodiments provides protection at the physical layer, thereby meeting fault recovery requirements for optical network systems, such as 50 millisecond fault recovery requirements in SONET systems. It should further be understood that while the example embodiments are presented in reference to core and access networks, these or other embodiments may be applied to other optical or electrical networks.

Further example embodiments of the present invention may include a non-transitory computer readable medium containing instruction that may be executed by a processor, and, when executed, cause the processor to protect a primary optical path employing a switch to transmit data from the primary path to a secondary path in a passive manner. It should be understood that elements of the block and flow diagrams described herein may be implemented in software, hardware, firmware, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read only memory (CD-ROM), and so forth. In operation, a general purpose or application specific processor loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments of the invention.

While this invention has been particularly shown and described with references to example embodiments thereof, it will be understood by those skilled in the art that various changes in form and details may be made therein without departing from the scope of the invention encompassed by the appended claims.

What is claimed is:

1. A central office comprising:
a primary optical line terminal (OLT) coupled to a passive optical network (PON) via a primary path and configured to transmit first data to an optical network terminal (ONT) via the PON; and
a secondary OLT configured to communicate to the PON via an optical switch in an event the optical switch detects a loss of signal event on the first PON.

2. The central office of claim 1 wherein the central office is interconnected with a network, the network having a proximal end and a distal end, the proximal end being closer to the OLT than the PON, the distal end being closer to the PON than the OLT, and wherein the switch is at the proximal end or closer to the proximal end than the distal end.

3. The central office of claim 1 further comprising at least one optical splitter/combiner (OSC) configured between the primary and secondary OLTs and the ONT.

4. The central office of claim 1 wherein the primary and secondary OLTs are configured to receive signals from the same upstream network.

5. The central office of claim 1 wherein the primary and secondary OLTs are configured to receive signals from a different upstream network.

6. The central office of claim 1 wherein the switch is an optical cross-connect switch configured to switch high-speed optical signals.

7. The central office of claim 1 wherein the switch includes circuitry configured to monitor the primary path.

8. The central office of claim 1 wherein the switch is further configured to switch, upon detection of a failure event, the signal from the primary path to the secondary path of the secondary OLT.

9. A central office comprising:
a primary optical line terminal (OLT) coupled to a first passive optical network (PON) via a primary path and configured to transmit first data to a first optical network terminal (ONT) via the first PON;
a secondary OLT coupled to a second PON via a secondary path and configured to transmit second data to a second optical network terminal (ONT) via the second PON; and
a switch operably interconnected to the primary and secondary paths, the switch configured to monitor the primary path for a loss of signal event and, in such an event, change its configuration to optically couple the secondary OLT to the first PON to enable the first data to be transmitted to the first PON and the second data to be transmitted to the second PON.

10. The central office of claim 9 wherein the central office is interconnected to a network, the network having a proximal end and a distal end, the proximal end being closer to the OLT than the PON, the distal end being closer to the PON than the OLT, and wherein the switch is at the proximal end or closer to the proximal end than the distal end.

11. The central office of claim 9 wherein the primary and secondary OLTs are configured to receive signals from the same upstream network.

12. The central office of claim 9 wherein the primary and secondary OLTs are configured to receive signals from a different upstream network.

13. The central office of claim 9 wherein the switch is an optical cross-connect switch configured to switch high-speed optical signals.

14. The central office of claim 9 wherein the switch comprises circuitry configured to monitor the primary path.

15. The central office of claim 9 wherein the switch is further configured to switch, upon detection of a failure event, the signal from the primary path to the secondary path of the secondary OLT.

16. The central office of claim 9 wherein the secondary OLT is configured to act as a protection OLT.

17. The central office of claim 9 further comprising additional optical splitters/combiners (OSCs) and additional switches such that more than two OLTs are configured to service additional PONs.

18. The central office of claim 17 wherein at least one OSC is configured between the primary and secondary OLTs and the ONT.

19. A hybrid passive optical network comprising:
a first passive optical network (PON) path spanning between a primary optical line terminal (OLT) and an optical network terminal (ONT); and
a second PON path spanning between a secondary OLT and the ONT via a physical optical switch, the physical optical switch operably interconnected to the first and second PON paths, the switch configured to detect a loss of signal event on the first PON path, and, responsive to the event, optically couple the secondary OLT to the ONT.

20. The network of claim 19 wherein the network has a proximal end and a distal end, the proximal end being closer to the OLT than the PON, the distal end being closer to the PON than the OLT, and wherein the switch is at the proximal end or closer to the proximal end than the distal end.

21. The network of claim 20 further comprising at least one optical splitter/combiner (OSC) configured between the primary and secondary OLTs and the ONT.

22. The network of claim 21 wherein at least one OSC is configured between the primary and secondary OLTs and the ONT.

23. The network of claim 19 wherein the primary and secondary OLTs are configured to receive signals from the same upstream network.

24. The network of claim 19 wherein the primary and secondary OLTs are configured to receive signals from a different upstream network.

25. The network of claim 19 wherein the switch is an optical cross-connect switch configured to switch high-speed optical signals.

26. The network of claim 19 wherein the switch comprises circuitry configured to monitor the primary path.

27. The network of claim 19 wherein the switch is further configured to switch, upon detection of a failure event, the signal from the primary path to the secondary path of the secondary OLT.

28. A method of protecting a primary optical path, the method comprising:
transmitting first data from a primary optical line terminal (OLT) to a first optical network terminal (ONT) via a passive optical network (PON), the primary OLT being coupled to the PON via a primary path; and
switching the first data from a secondary OLT to the PON via an optical switch, if the optical switch detects a loss of signal event on the first PON.

29. The method of claim 28 further comprising:
maintaining the optical switch operably interconnected to the primary and secondary paths;
monitoring, at the optical switch, the primary path for a loss of signal event;
changing, in such an event, its configuration to couple optically the secondary OLT to the first PON; and
enabling the first data to be transmitted to the first PON and the second data to be transmitted to the second PON.

30. The method of claim 29 wherein the optical switch further includes an optical cross-connect switch for switching high-speed optical signals.

31. The method of claim 28 further comprising optically splitting and combining wavelengths between the primary and secondary OLTs and the ONT.

32. The method of claim 29 further comprising monitoring the primary path at the optical switch.
